(19) United States
(12) Patent Application Publication
(10) Pub. No.: US 2009/0167984 A1
(43) Pub. Date: Jul. 2, 2009

(54) BACKLIGHT UNIT, DISPLAY DEVICE HAVING THE SAME, AND METHOD THEREOF

(75) Inventors: Sang-Hoon LEE, Yongin-si (KR); Hyeon-Seok BAE, Asan-si (KR); Cheol-Ho LEE, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/238,619

(22) Filed: Sep. 26, 2008

(30) Foreign Application Priority Data
Jan. 2, 2008 (KR) 10-2008-0000187

(51) Int. Cl. G02F 1/13357; F21V 5/00

(52) U.S. Cl. 349/64; 362/246

(57) ABSTRACT

A backlight unit, and a display device having the backlight unit, includes a light source, the light source formed to directly illuminate a display panel, and an optical plate arranged over the light source, wherein the optical plate includes a first surface and a second surface that faces the first surface, and the first surface is different in height from the second surface.

This application claims priority to Korean Patent Application No. 10-2008-000187, filed on Jan. 2, 2008, and all the benefits accruing therefrom under 35 U.S.C. §119, the contents of which in its entirety are herein incorporated by reference.

### BACKGROUND OF THE INVENTION

1. Field of the Invention

The present invention relates to a backlight unit, a display device having the backlight unit, and a method thereof. In particular, the present invention relates to a backlight unit preventing deformations, a display device having the backlight unit, and a method of preventing deformation within a display device.

2. Description of the Related Art

Various electronics, such as mobile phones, TVs, laptop computers, etc. include a display device to represent images. Recently, flat panel display devices are mainly used owing to their compact and slim size.

A liquid crystal display (“LCD”) device, a representative flat panel display device, displays images using electrical and optical properties of liquid crystal molecules. The LCD device has a compact and slim size, reduced power consumption and driving voltage in comparison with other types of flat panel display devices, so that the LCD device is applied for various industrial fields.

An LCD device includes an LCD panel for displaying images, a driving circuit for driving the LCD panel, and a backlight unit for supplying light to the LCD panel. The backlight unit includes a light source for irradiating light and an optical plate for improving light efficiency.

The backlight unit stands vertically to the ground when the backlight unit is received in a display device and the display device is properly positioned for use.

### BRIEF SUMMARY OF THE INVENTION

It has been determined herein, according to the present invention, that when an LCD device including a conventional backlight unit stands vertically to the ground, deformations such as bending and twisting may occur due to affects of temperature or moisture. These deformations could also give rise to deteriorations of the LCD device, such as brightness and darkness. In addition, the increase in weight of the optical plate, as used for a large screen LCD device, could lead to easier deformations.

An aspect of the present invention provides a backlight unit capable of preventing its deformations caused by load of optical sheets.

Another aspect of the present invention provides a display device including the backlight unit.

Yet another aspect of the present invention provides a method of preventing deformations within a display device.

Exemplary embodiments of the present invention provide a backlight unit including a light source, the light source formed to directly illuminate a display panel, and an optical plate arranged over the light source, wherein the optical plate includes a first surface and a second surface that faces the first surface, and the first surface is different in height from the second surface.

The optical plate may further include a third surface and an opposing fourth surface that are connected between the first and second surfaces.

One of the third surface and fourth surface may be inclined by a prescribed angle.

The angle may be more than about 0 degrees and less than about a value that is calculated from an equation, tan⁻¹(H/L), wherein H refers to a height of the second surface and L refers to a length between the first surface and second surface.

In an alternative exemplary embodiment, the first and second surfaces may be inclined by prescribed angles.

The angles may be more than about 0 degrees and less than about a value that is calculated from an equation, tan⁻¹(H/L), wherein H refers to a height of the second surface and L refers to a length between the first surface and second surface.

The optical plate may diffuse light.

The optical plate may have a haze value ranging from about 80% to about 99%.

The optical plate may be formed so that the first surface corresponding to a top surface may be smaller in height than the second surface corresponding to a bottom surface when a display device receiving the optical plate stands vertically.

The fourth surface may face the light source, the third surface may be arranged to face the display panel, and the third and fourth surfaces may not be parallel to each other.

Exemplary embodiments of the present invention also provide a display device including a display panel to display images, a driver to drive the display panel, and a backlight unit, wherein the backlight unit includes a light source, the light source formed to directly illuminate the display panel, and an optical plate arranged over the light source, wherein the optical plate includes a first surface and a second surface that faces the first surface, and the first surface is different in height from the second surface.

The optical plate may further include a third surface and an opposing fourth surface that are connected between the first and second surfaces.

One of the third surface and fourth surface may be inclined by a prescribed angle.

The angle may be more than about 0 degrees and less than about a value that is calculated from an equation, tan⁻¹(H/L), wherein H refers to a height of the second surface and L refers to a length between the first surface and second surface.

In an alternative exemplary embodiment, the first and second surfaces may be inclined by prescribed angles.

The angles may be more than about 0 degrees and less than about a value that is calculated from an equation, tan⁻¹(H/L), wherein H refers to a height of the second surface and L refers to a length between the first surface and second surface.

The optical plate may diffuse light.

The optical plate may have a haze value ranging from about 80% to about 99%.

The optical plate may be formed so that the first surface corresponding to a top surface is smaller in height than the second surface corresponding to a bottom surface when the display device stands vertically.

Exemplary embodiments of the present invention also provide a method of preventing deformations of a backlight unit within a display device, the display device including a display panel and the backlight unit, the backlight unit including a light source directly illuminating the display panel and an optical plate arranged between the light source and the display panel, the method including forming a first surface of the optical plate with a smaller height than a height of an opposing second surface of the optical plate, the first surface and the second surface facing neither the display panel nor the light source, wherein, when the display device stands vertically, the first surface corresponds to a top surface of the display device and the second surface corresponds to a bottom surface of the display device.

### BRIEF DESCRIPTION OF THE DRAWINGS

The above and other features of the present invention will be described in reference to certain exemplary embodiments thereof with reference to the attached drawings in which:

FIG. 1 is an exploded perspective view illustrating an exemplary display device according to an exemplary embodiment of the present invention;

FIG. 2 is a cross sectional view taken along line I-I′ of FIG. 1;

FIG. 3 is a perspective view illustrating an exemplary light diffusion member of an exemplary backlight unit according to an exemplary embodiment of the present invention;

FIGS. 4A and 4B are side views of a first exemplary light diffusion member of a backlight unit; and

FIGS. 5A and 5B are side views of a second exemplary light diffusion member of a backlight unit.

### DETAILED DESCRIPTION OF THE INVENTION

The invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

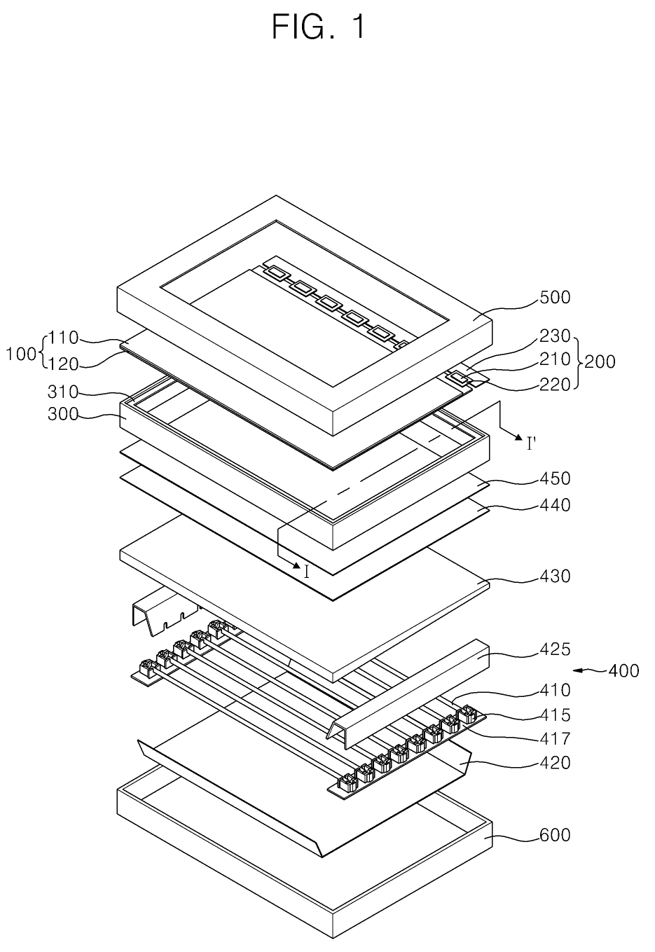

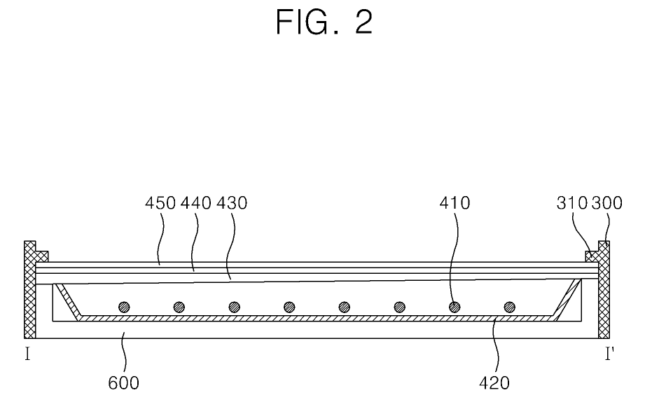

FIG. 1 is an exploded perspective view illustrating an exemplary display device according to an exemplary embodiment of the present invention, and FIG. 2 is a cross sectional view taken along line I-I′ of FIG. 1.

Referring to FIGS. 1 and 2, the display device includes a display panel 100, a panel driver 200, a mold frame 300, a backlight unit 400, a top chassis 500, and a bottom chassis 600.

The display panel 100 includes a color filter substrate 110 and a thin film transistor (“TFT”) substrate 120 which are attached to each other. The display panel 100 may further include a liquid crystal layer between the substrates 110 and 120 to adjust light transmittance.

The color filter substrate 110 may include a black matrix, a color filter, a common electrode, and an upper alignment layer. The black matrix, which is shaped as a matrix is formed on an upper substrate of glass or plastic to block light. The color filter includes red, green, and blue (“RGB”) color filters which are formed on portions defined by the black matrix to implement red, green, and blue, respectively. In an alternative exemplary embodiment, the color filters may be formed on the TFT substrate 120. The common electrode supplies a common voltage to the liquid crystal layer. The upper alignment layer is applied on the common electrode to align the liquid crystal molecules.

The TFT substrate 120 includes a data line, a gate line, a TFT, a pixel electrode, and a lower alignment layer. The data line and the gate line intersect each other on a lower substrate with a gate insulation layer therebetween, and the lower substrate is made of glass or plastic. The TFT is electrically connected to the data line and gate line. The pixel electrode applies a pixel voltage to the liquid crystal layer. In an alternative exemplary embodiment, the common electrode may be formed on the TFT substrate 120, in which case the pixel electrode and the common electrode may be formed in a stripe pattern on the TFT substrate 120. The lower alignment layer is applied on the pixel electrode to align the liquid crystal molecules.

The panel driver 200 is electrically connected to a side of the TFT substrate 120 to supply a driving signal to the data line and gate line of the display panel 100. The panel driver 200 includes a data line driver 210 for driving the data line and a gate line driver for driving a gate line.

The data line driver 210 is mounted in a film-type tape carrier package (“TCP”) and electrically connected to the TFT substrate 120. The data line driver 210 is electrically connected to a printed circuit board (“PCB”) 230, and the PCB 230 is electrically connected to an end of the TCP 220. The PCB 230 on which various elements, such as a timing controller, and a power supply, are mounted, supplies power, image data, and control signals to the data line driver 210 and gate line driver.

The gate line driver may be integrated with the TFT substrate 120 and electrically connected to the gate line. The gate line driver may be mounted on the TFT substrate 120 in a chip on glass (“COG”) form. In an alternative exemplary embodiment, the gate line driver may be mounted in a TCP and electrically connected to the TFT substrate 120.

The mold frame 300 receives the display panel 100 therein to protect the display panel 100 from external impacts. The mold frame 300 includes a receiving part 310 for receiving the display panel 100. The mold frame 300 may be formed of a material such as plastic to absorb external impacts.

The backlight unit 400 is arranged under the display panel 100 to supply light to the display panel 100. The backlight unit 400 includes a light source 410, a socket 415, a reflective member 420, a light diffusion member 430, a light collection member 440, and a protective member 450.

The light source 410 generates light to illuminate the display panel 100. In an exemplary embodiment, the light source 410 is formed to directly illuminate the display panel 100 from under the display panel 100. The light source 410 may include a cold cathode fluorescent lamp (“CCFL”), an external electrode fluorescent lamp (“EEFL”), or multiple light emitting diodes (“LEDs”). In an alternative exemplary embodiment, the light source 410 may be formed to illuminate the display panel 100 from a side of the display panel 100.

In an exemplary embodiment of the light source 410 that includes a lamp, the socket 415 is arranged near both ends of the light source 410 to hold and fix the light source 410. The socket 415 is provided in plural on a connection member 417, and power is supplied to the light source 410 through the connection member 417.

The backlight unit 400 may further include a side mold 425 to protect ends of the light source 410 and the socket 415. The side mold 425 includes an opening to wrap around ends of the light source 410 to protect the light source 410 and socket 415, and is formed to have a prescribed height. Also, the side mold 425 supports the light diffusion member 430, light collection member 440, and protective member 450 to be spaced from the light source 410. The side mold 425 may include a step portion at its upper side to support the light diffusion member 430, light collection member 440, and protective member 450 thereon.

The reflective member 420 is arranged under the light source 410, and the reflective member 420 may be formed of a plate having a high reflectivity. The reflective member 420 reflects the light from the light source 410 directed downward back to the display panel 100. This helps reduce light loss. For this purpose, the reflective member 420 may be coated with a high-reflectivity material.

The light diffusion member 430 diffuses light supplied from the light source 410 all over the display panel 100. The light diffusion member 430 may have a haze value ranging from about 80% to about 90%. The “haze value” refers to a ratio of scattered rays to whole rays. A haze value of about less than 80% could result in a bright line phenomenon. A haze value of about more than 99% could lead to elimination of direct light, which may reduce the light diffusion efficiency.

The light collection member 440 allows the light diffused by the light diffusion member 430 to be directed to the display panel 100.

The protective member 450 protects the light collection member 440 from damages, such as scratching.

The top chassis 500 is arranged above the display panel 100 to protect the display panel 100 from external impacts. The top chassis 500 has an opening at its center to expose the display region of the display panel 100, and the top chassis 500 surrounds the periphery of the display panel 100.

The bottom chassis 600 receives the backlight unit 400 therein and is combined with the top chassis 500 to protect the backlight unit 400 from external impacts.

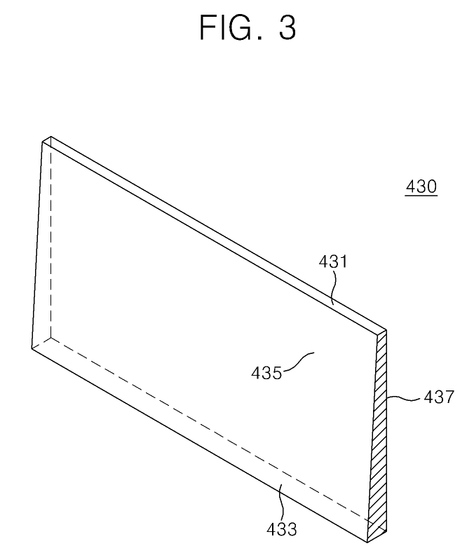

FIG. 3 is a perspective view illustrating an exemplary light diffusion member of an exemplary backlight unit according to an exemplary embodiment of the present invention.

Referring to FIG. 3, the light diffusion member 430 includes a first surface 431, a second surface 433, a third surface 435, and a fourth surface 437.

When a display device including the backlight unit 400 is positioned vertically, the first surface 431 and second surface 433 of the light diffusion member 430 correspond to the top surface and bottom surface, respectively. In an exemplary embodiment, the first surface 431 and the second surface 433 face neither the display panel 100 nor the light source 410. The third surface 435 and fourth surface 437 correspond to the front surface and rear surface, respectively. The third surface 435 and fourth surface 437 are connected to the first and second surfaces 431 and 433. In use within the display device, the third surface 435 faces the display panel 100 and the fourth surface 437 faces the light source 410. The light diffusion member 430 is arranged within the display device such that the light source 410 directly faces the fourth surface 437 so that light from the light source 410 enters the light diffusion member 430 through the fourth surface 437 and exits the light diffusion member 430 through the third surface 435.

The first surface 431 is formed to be thinner in thickness than the second surface 433, such that the first surface 431 has a width that is narrower than a width of the opposing second surface 433. That is, the light diffusion member 430 is formed to be thicker as going from its top surface to its bottom surface. This structure can reduce the pressure exerted from the upper side of the light diffusion member 430, so that the light diffusion member 430 may endure its own load. Thus, deformations of the light diffusion member 430 such as bending and twisting may be preventable.

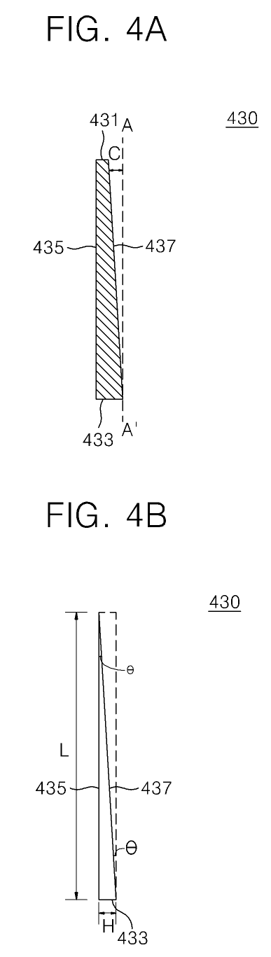

FIGS. 4A and 4B are side views of a first exemplary light diffusion member of a backlight unit.

Referring to FIGS. 4A and 4B, the light diffusion member 430 includes a first surface 431, a second surface 433, a third surface 435, and a fourth surface 437. The first and second surfaces 431 and 433 are parallel with each other. In this exemplary embodiment, the third surface 435 is formed to be perpendicular to the first surface 431 and the second surface 433, and connected between the first and second surfaces 431 and 433. The fourth surface 437 is inclined by a prescribed angle (C) from the virtual reference line A-A′ that is parallel with the third surface 435. At this time, the angle (C) can be measured from an angle (0) indicated in FIG. 4B. In FIG. 4B, the angle (θ) refers to the maximum value by which the fourth surface 437 can be formed. The angle (θ) can be represented as Equation 1:

$$θ = {tan}^{- 1} \frac{H}{ L} , ( 0 ° < θ < 90 ° ) \qquad < Equation 1 >$$

where H refers to the height of the second surface 433, and L refers to the length of the third surface 435.

The height H of the second surface 433 may also refer to the width or thickness of the second surface 433. The angle (θ) may range from about 0° to about a value that can be calculated from Equation 1. The angle (θ) may change depending on H and L. For example, as L increases and H decreases, the angle (θ) may be reduced correspondingly. In this case, the region within which the height of the first surface 431 can be changed increases. Accordingly, the region within which the load is exerted on the first surface 431 decreases. As L decreases and H increases, the angle (θ) may be increased correspondingly. In this case, the region within which the height of the first surface 431 can be changed decreases. Accordingly, the region within which the load is exerted on the first surface 431 increases.

The first surface 431 may have a minimum height to maintain the uniformity of light diffusion. In this case, the fourth surface 437 may be formed so that the angle (θ) is more than about 0° and less than about 30°. More particularly, the fourth surface 437 may be formed so that the angle (θ) is more than about 0° and less than about 15°.

While the fourth surface 437 has been described as formed at the angle (θ), in an alternative exemplary embodiment, the fourth surface 437 may be formed to be substantially perpendicular with the first surface 431 and the second surface 433, and the third surface 435 may be formed at the angle (θ), such that the first surface 431 has a smaller height H than the height H of the second surface 433.

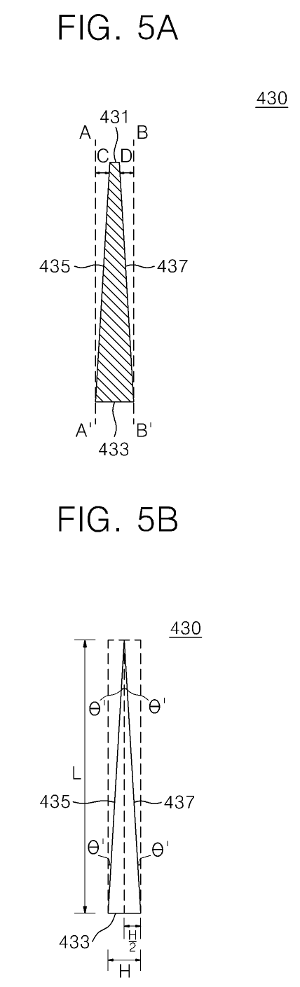

FIGS. 5A and 5B are side views of a second exemplary light diffusion member of a backlight unit.

Referring to FIGS. 5A and 5B, the light diffusion member 430 includes a first surface 431, a second surface 433, a third surface 435, and a fourth surface 437. The third and fourth surface 435 and 437 are inclined by prescribed angles (C and D) from the virtual reference lines A-A′ and B-B′, respectively. The third and fourth surfaces 435 and 437 are connected between the first and second surfaces 431 and 433. The angles (C and D) may be measured from the angle (θ′) indicated in FIG. 5B. In FIG. 5B, the angle (θ′) refers to the maximum value by which the third and fourth surfaces 435 and 437 can be formed. The angle (θ′) can be represented as Equation 2:

$${θ}^{′} = {tan}^{- 1} \frac{H}{2 L} , ( 0 ° < θ < 90 ° ) \qquad < Equation 2 >$$

where H refers to the height of the second surface 433, and L refers to the length or distance between the first surface 431 and second surface 433.

The angle (θ′) may range from about 0° to about a value that can be calculated from Equation 2. The angle (θ′) can change depending on H and L. For example, as L increases and H decreases, the angle (θ′) may be reduced correspondingly. In this case, the region within which the first surface 431 can be changed increases. Accordingly, the region within which the load is exerted on the first surface 431 decreases. As L decreases and H increases, the angle (θ′) may be increased correspondingly In this case, the region within which the height of the first surface 431 can be changed decreases. Accordingly, the region within which the load is exerted on the first surface 431 increases.

The first surface 431 may have a minimum height to maintain the uniformity of light diffusion. Each of the third surface 435 and fourth surface 437 may be formed so that the angle (θ′) is more than about 0° and less than about 15°. More particularly, the angle (θ′) may be more than about 0° and less than about 7°.

Such a structure that the top surface is different in height from the bottom surface may be applicable to other optical plates, such as the light collection member 440, as well as the light diffusion member 430.

Additionally, the light diffusion member 430 may include marks to differentiate the first surface 431 and the second surface 433. Such marks may include protrusions or alignment keys. The marks may help clearly differentiate the first and second surfaces 431 and 433 so that the first surface 431 can be arranged to be the top surface when the display device, receiving the light diffusion member 430, stands vertically.

As described above, the optical plate according to exemplary embodiments of the present invention, is formed so that its top surface is narrower than its bottom surface, as the display devices receiving the optical plate stands vertically. This enables preventing physical deformations of the optical plate, such as winding or twisting, because the load of the top surface decreases and the load of the bottom surface scatters.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A backlight unit comprising:
a light source formed to directly illuminate a display panel; and
an optical plate arranged over the light source,
wherein the optical plate comprises a first surface and a second surface facing the first surface, and
wherein the first surface is different in height from the second surface.

2. The backlight unit of claim 1, wherein the optical plate further comprises a third surface and an opposing fourth surface connected with each other between the first and second surfaces.

3. The backlight unit of claim 2, wherein one of the third surface and fourth surface is inclined by a prescribed angle.

4. The backlight unit of claim 3, wherein the angle is more than about 0 degrees and less than about a value that is calculated from an equation, tan⁻¹(H/L), and
H refers to a height of the second surface and L refers to a length between the first surface and second surface.

5. The backlight unit of claim 2, wherein the first and second surfaces are inclined by prescribed angles.

6. The backlight unit of claim 5, wherein the angles are more than about 0 degrees and less than about a value that is calculated from an equation, tan⁻¹(H/2L), and
H refers to a height of the second surface and L refers to a length between the first surface and second surface.

7. The backlight unit of claim 2, wherein the fourth surface faces the light source, the third surface is arranged to face the display panel, and the third and fourth surfaces are not parallel to each other.

8. The backlight unit of claim 1, wherein the optical plate diffuses light.

9. The backlight unit of claim 8, wherein the optical plate has a haze value ranging from about 80% to about 99%.

10. The backlight unit of claim 1, wherein the optical plate is formed so that the first surface corresponding to a top surface of the optical plate is smaller in height than the second surface corresponding to a bottom surface of the optical plate when a display device receiving the optical plate stands vertically.

11. A display device comprising:
a display panel to display images;
a driver to drive the display panel; and
a backlight unit, and
wherein the backlight unit comprises a light source, the light source formed to directly illuminate the display panel; and an optical plate arranged over the light source, the optical plate comprising a first surface and a second surface that faces the first surface, and the first surface is different in height from the second surface.

12. The display device of claim 11, wherein the optical plate further comprises a third surface and an opposing fourth surface that are connected between the first and second surfaces.

13. The display device of claim 12, wherein one of the third surface and fourth surface is inclined by a prescribed angle.

14. The display device of claim 13, wherein the angle is more than about 0° and less than about a value that is calculated from an equation, tan⁻¹(H/L), and H refers to a height of the second surface and L refers to a length between the first surface and second surface.

15. The display device of claim 12, wherein the first and second surfaces are inclined by prescribed angles.

16. The display device of claim 15, wherein the angles are more than about 0° and less than about a value that is calculated from an equation, tan⁻¹(H/2L), wherein H refers to a height of the second surface and L refers to a length between the first surface and second surface.

17. The backlight unit of claim 12, wherein the fourth surface faces the light source, the third surface faces the display panel, and the third and fourth surfaces are not parallel to each other.

18. The display device of claim 11, wherein the optical plate diffuses light.

19. The display device of claim 18, wherein the optical plate has a haze value ranging from about 80% to about 99%.

20. The display device of claim 11, wherein the optical plate is formed so that the first surface corresponding to a top surface is smaller in height than the second surface corresponding to a bottom surface when the display device stands vertically.

21. A method of preventing deformations of a backlight unit within a display device, the display device including a display panel and the backlight unit, the backlight unit including a light source directly illuminating the display panel and an optical plate arranged between the light source and the display panel, the method comprising:
forming a first surface of the optical plate with a smaller height than a height of an opposing second surface of the optical plate, the first surface and the second surface facing neither the display panel nor the light source, wherein, when the display device stands vertically, the first surface corresponds to a top surface of the display device and the second surface corresponds to a bottom surface of the display device.
